(19) United States
(12) Patent Application Publication
(10) Pub. No.: US 2013/0034048 A1
(43) Pub. Date: Feb. 7, 2013

(54) COMMUNICATION SYSTEM, COMMUNICATION RELAY DEVICE, AND COMMUNICATION CONTROL METHOD

(71) Applicants: Hiroyuki Adachi, Kanagawa (JP); Shingo Joko, Kanagawa (JP)

(72) Inventors: Hiroyuki Adachi, Kanagawa (JP); Shingo Joko, Kanagawa (JP)

(73) Assignee: KYOCERA CORPORATION, Kyoto (JP)

(21) Appl. No.: 13/641,309

(22) PCT Filed: Apr. 14, 2011
(86) PCT No.: PCT/JP2011/059314

§ 371 Date: Oct. 15, 2012

(30) Foreign Application Priority Data
Apr. 16, 2010 (JP) 2010-095545

(51) Int. Cl. H04W 88/04

(52) U.S. Cl. 370/315

(57) ABSTRACT

An SISO-AF relay node 300-1 and an SISO-AF relay node 300-2 in a relay node system 1 receive signals of communication streams from a transmitting antenna 101 and a transmitting antenna 102 in a macrocell base station 100 through a receiving antenna 301 and a receiving antenna 302, amplify the signals of the communication streams, and transmit them to a radio terminal 200 through a transmitting antenna 303 and a transmitting antenna 304.

### TECHNICAL FIELD

The present invention relates to: a communication system including multiple communication relay devices configured to relay radio communication between a first communication device and a second communication device; the communication relay device; and a communication control method in the communication system.

### BACKGROUND ART

As the next generation radio communication system to achieve higher-speed, larger-capacity communication, there is LTE which is standardized by the 3GPP being a standardization organization for radio communication systems. The technical specifications of LTE have been determined as 3GPP Release 8, and LTE-Advanced is currently under discussion.

In LTE-Advanced, an MIMO (Multi Input Multi Output) relay node or the like is placed as a device to relay radio communication between a macrocell base station (MeNB) of large output and a radio terminal (UE), in order to increase the system capacity and coverage and to distribute the traffic. Such a configuration of a radio communication system is called a heterogeneous network.

### CITATION LIST

### Non-Patent Literature

Non-patent Literature 1: 3GPP, RP-090665, Qualcomm, “Revised SID on LTE-Advanced”, May 2009.

### SUMMARY OF THE INVENTION

However, there is a problem that MIMO relay nodes are costly. Moreover, in a case of using a single MIMO relay node to implement relay of radio communication between a radio base station and a radio terminal, the MIMO relay node including antennas placed at a relatively short distance has problems of imposing limitations on reduction in the spatial correlation and improvement in the performance of separating communication streams at the radio terminal.

In this respect, an objective of the present invention is to provide a communication system, a communication relay device, and communication control method achieving both a low cost and an improved reception performance.

The present invention has the following features to solve the problems described above. A first feature of the present invention is summarized as follows. A communication system (relay node system 1) comprises a plurality of communication relay devices (SISO-AF relay node 300-1, SISO-AF relay node 300-2) configured to relay radio communication between a first communication device (macrocell base station 100) and a second communication device (radio terminal 200), wherein each of the plurality of communication relay devices comprises: a receiving antenna (receiving antenna 301, receiving antenna 302) being not greater in number than one or more transmitting antennas in the first communication device or other communication relay devices, and configured to receive signals of communication data series (communication stream) from the transmitting antennas in the first communication device or other communication relay devices; an amplifying unit (service-side radio communication unit 306) configured to amplify the signals of the communication data series received by the receiving antenna; and a transmitting antenna (transmitting antenna 303, transmitting antenna 304) configured to transmit the signals of the communication data series amplified by the amplifying unit to the second communication device or other communication relay devices, wherein MIMO (Multi Input Multi Output) transmission is performed between the first communication device and the second communication device through the plurality of communication relay devices, the MIMO transmission being designed to transmit signals of different communication data series by using the same frequency.

Each of the multiple communication relay devices receives signals of communication data series through its receiving antenna being not greater in number than the transmitting antennas in the first communication device or other communication relay devices, amplifies the signals of the communication data series, and transmits them through its transmitting antenna to the second communication device or other communication relay devices, whereby such a communication system performs the MIMO transmission between the first communication device and the second communication device in relaying the radio communication between the first communication device and the second communication. In this way, the cost is reduced as compared to a case of using only one costly MIMO relay node at one relay stage to relay the radio communication between the first communication device and the second communication device. Moreover, the inter-antenna distance can be widened and the reception performance at the second communication device can therefore be improved as compared to a case of using one MIMO relay node to implement the radio communication between the first communication device and the second communication device.

A second feature of the present invention is summarized as follows. The plurality of communication relay devices are each installed in a location where a propagation loss between the communication relay device and the first communication device is within a first predetermined range.

When the path loss between the first communication device and each communication relay device is within the first predetermined range as described above, the received power of the signals of the communication data series received by each receiving antenna in the second communication device can fall within a predetermined range. Accordingly, the reception performance can be improved.

A third feature of the present invention is summarized as follows. The amplifying unit changes an amplification factor in accordance with a path loss between the communication relay device and the first communication device.

A fourth feature of the present invention is summarized as follows. At least one of the plurality of communication relay devices performs SISO (Single Input Single Output) transmission.

A fifth feature of the present invention is summarized as follows. The amplifying unit in each of the plurality of communication relay devices has an amplifying characteristic within a second predetermined range and a delay characteristic within a third predetermined range.

A sixth feature of the present invention is summarized as follows. A communication relay device configured to relay radio communication between a first communication device and a second communication device in cooperation with other communication relay devices, the communication relay device comprises: a receiving antenna being not greater in number than one or more transmitting antennas in the first communication device or other communication relay devices, and configured to receive signals of communication data series from the transmitting antennas in the first communication device or other communication relay devices; an amplifying unit configured to amplify the signals of the communication data series received by the receiving antenna; and a transmitting antenna configured to transmit the signals of the communication data series amplified by the amplifying unit to the second communication device or other communication relay devices, wherein the communication relay device performs MIMO (Multi Input Multi Output) transmission between the first communication device and the second communication device in cooperation with the other communication relay devices, the MIMO transmission being designed to transmit signals of different communication data series by using the same frequency.

A seventh feature of the present invention is summarized as follows. A communication control method for a communication system comprises a plurality of communication relay devices configured to relay radio communication between a first communication device and a second communication device (radio terminal 200), the communication control method comprising the steps of: causing a receiving antenna in each of the plurality of communication relay devices, which is not greater in number than one or more transmitting antennas in the first communication device or other communication relay devices, to receive signals of communication data series from the transmitting antennas in the first communication device or other communication relay devices; causing each of the plurality of communication relay devices to amplify the received signals of the communication data series; and causing the one or more transmitting antennas in each of the plurality of communication relay devices to transmit the amplified signals of the communication data series to the second communication device or other communication relay devices, wherein MIMO (Multi Input Multi Output) transmission is performed between the first communication device and the second communication device through the plurality of communication relay devices, the MIMO transmission being designed to transmit signals of different communication data series by using the same frequency.

The present invention can achieve both a low cost and an improved reception performance.

### BRIEF DESCRIPTION OF THE DRAWINGS

FIG. 1 is a schematic overall configuration diagram of a radio communication system according to an embodiment of the present invention.

FIG. 2 is a diagram showing the configuration of a part of the radio communication system according to the embodiment of the present invention which is related to MIMO transmission.

FIG. 3 is a block diagram showing the configuration of the SISO-AF relay node 300-1.

FIG. 4 is a flowchart showing the operations of the SISO-AF relay node 300-1 according to the embodiment of the present invention.

FIG. 5 is a diagram showing the configuration of a part of the radio communication system according to the first to the third other embodiments of the present invention which is related to MIMO transmission.

FIG. 6 is a diagram showing the configuration of a part of the radio communication system according to the fourth other embodiment of the present invention which is related to MIMO transmission.

### DESCRIPTION OF THE EMBODIMENTS

Next, embodiments of the present invention will be described with reference to the drawings. Specifically, the embodiments of the present invention will be in sequence of (1) Configuration of Radio Communication System, (2) Operations of SISO-AF Relay Node, (3) Operations and Effects, and (4) Other Embodiments. The same or similar reference numerals are applied to the same or similar parts in the description of the drawings in the following embodiments.

(1) Configuration of Radio Communication System

(1.1) Schematic Overall Configuration of Radio Communication System

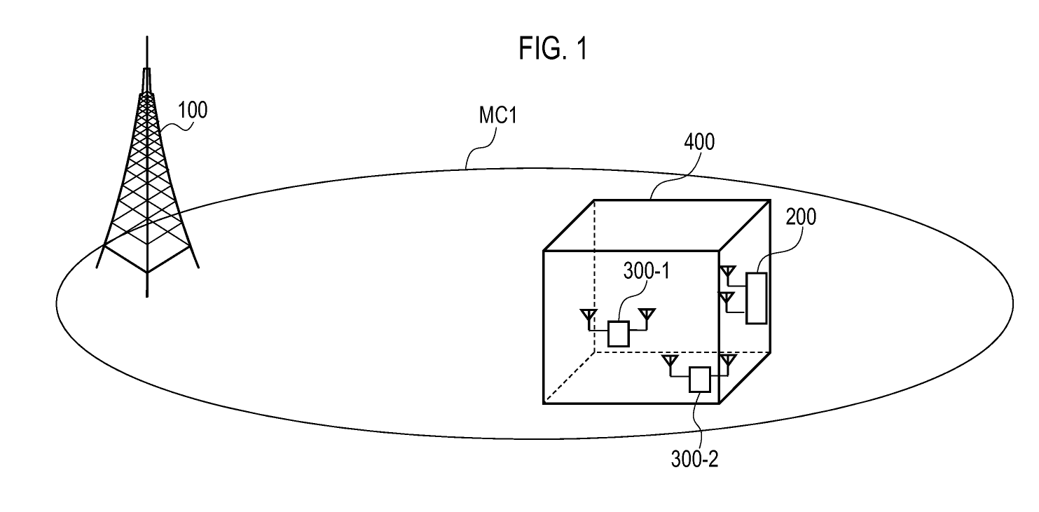

FIG. 1 is a schematic overall configuration diagram of a radio communication system according to an embodiment of the present invention. The radio communication system has a configuration based on LTE-Advanced which is considered a 4th generation (4G) mobile phone system, for example.

As shown in FIG. 1, the radio communication system includes: a macrocell base station (MeNB) 100 configured to forma large cell (e.g., a macrocell) MC1; a single-input single-output SISO (Single Input Single Output)-AF (Amplify and Forward) relay node 300-1 and a single-input single-output SISO-AF relay node 300-2 serving as communication relay devices installed inside a building 400; and a radio terminal (UE) 200 located inside the building 400. Note that the SISO-AF relay node 300-1 and the SISO-AF relay node 300-2 are also called repeaters.

The radio communication system shown in FIG. 1 performs downlink radio communication directed from the macrocell base station 100 through the SISO-AF relay node 300-1 and the SISO-AF relay node 300-2 to the radio terminal 200.

The SISO-AF relay node 300-1 and the SISO-AF relay node 300-2 are installed in locations where the propagation loss between them and the macrocell base station 100 is within a first predetermined range (e.g., being equal). For example, an operator measures the received power of a signal of a communication stream from the macrocell base station 100 at multiple spots inside the building 400. Further, the SISO-AF relay node 300-1 and the SISO-AF relay node 300-2 are installed respectively at two spots where the measured received power is within the first predetermined range.

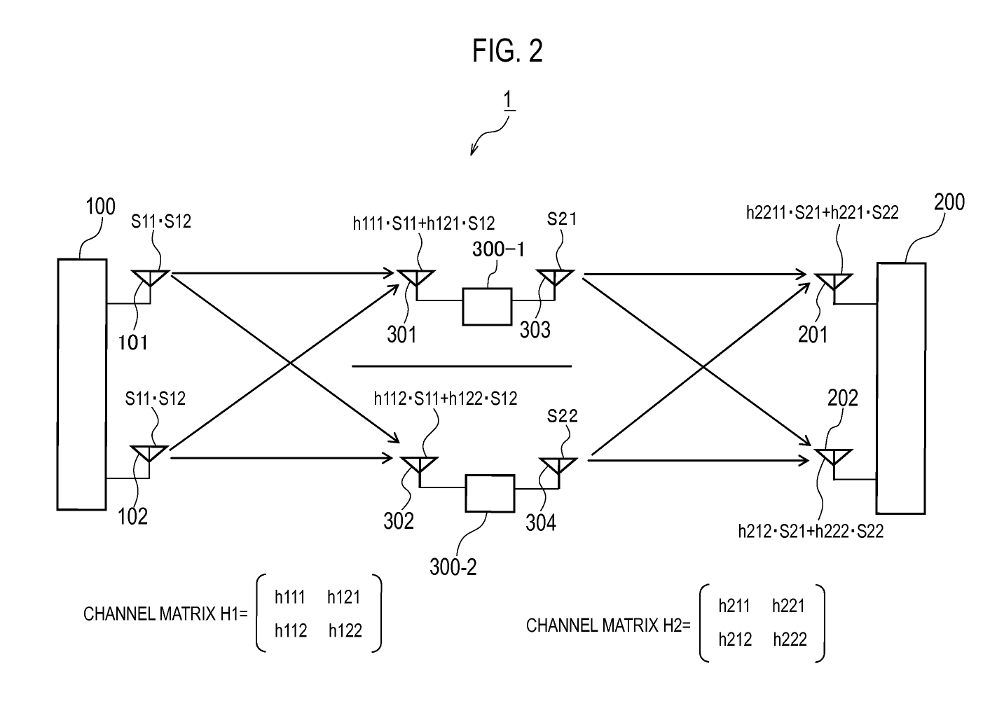

FIG. 2 is a diagram showing the configuration of a part of the radio communication system according to the embodiment of the present invention which is related to MIMO transmission.

The SISO-AF relay node 300-1 and the SISO-AF relay node 300-2 shown in FIG. 2 form a relay node system 1.

The macrocell base station 100 includes a transmitting antenna 101 and a transmitting antenna 102. The macrocell base station 100 is configured to multiplex and transmit a communication stream S11 and a communication stream S12 different from the communication stream S11 from the transmitting antenna 101 and the transmitting antenna 102 by using a first frequency band.

The SISO-AF relay node 300-1 includes a receiving antenna 301. The SISO-AF relay node 300-2 includes a receiving antenna 302. The receiving antenna 301 and the receiving antenna 302 are each configured to receive a communication stream in which the communication stream from the transmitting antenna 101 and the communication stream from the transmitting antenna 102 are multiplexed (synthesized).

The state of radio paths between the macrocell base station 100 and the SISO-AF relay node 300-1 and SISO-AF relay node 300-2 can be expressed with a channel matrix H1.

The channel matrix H1 is a 2×2 matrix because the macrocell base station 100 on the transmitting side includes the transmitting antenna 101 and the transmitting antenna 102 while the SISO-AF relay node 300-1 and the SISO-AF relay node 300-2 on the receiving side include the receiving antenna 301 and the receiving antenna 302. In the channel matrix H1, the component at the first row and first column is h111, the component at the first row and second column is h121, the component at the second row and first column is h112, and the component at the second row and second column is h122.

A communication stream R11 received by the receiving antenna 301 is h111·S11+h121·S12 by using the channel matrix Hl. A communication stream R12 received by the receiving antenna 302 is h112·S11+h122·S12 by using the channel matrix H1.

The SISO-AF relay node 300-1 includes a transmitting antenna 303. The SISO-AF relay node 300-2 includes a transmitting antenna 304. The SISO-AF relay node 300-1 is configured to amplify the signals received through the receiving antenna 301 and to transmit the amplified signals through the transmitting antenna 303 (transmission of a communication stream S21). The SISO-AF relay node 300-2 is configured to amplify the signals received through the receiving antenna 302 and to transmit the amplified signals through the transmitting antenna 303 (transmission of a communication stream S22).

The radio terminal 200 includes a receiving antenna 201 and a receiving antenna 202. The receiving antenna 201 and the receiving antenna 202 are each configured to receive a communication stream in which the communication stream from the transmitting antenna 303 and the communication stream from the transmitting antenna 304 are synthesized.

The state of radio paths between the SISO-AF relay node 300-1 and SISO-AF relay node 300-2 and the radio terminal 200 can be expressed with a channel matrix H2.

The channel matrix H2 is a 2×2 matrix because the SISO-AF relay node 300-1 and the SISO-AF relay node 300-2 on the transmitting side include the transmitting antenna 303 and the transmitting antenna 304 while the radio terminal 200 on the receiving side includes the receiving antenna 201 and the receiving antenna 202. In the channel matrix H2, the component at the first row and first column is h211, the component at the first row and second column is h221, the component at the second row and first column is h212, and the component at the second row and second column is h222.

A communication stream R21 received by the receiving antenna 201 is h211·S21+h221·S22 by using the channel matrix H2. A communication stream R22 received by the receiving antenna 202 is h212·S21+h222·S22 by using the channel matrix H2.

The radio terminal 200 is configured to acquire the communication stream S11 transmitted by the transmitting antenna 101 of the macrocell base station 100 and the communication stream S12 transmitted by the transmitting antenna 102 of the macrocell base station 100, by using the communication stream R21 received by the receiving antenna 201, the communication stream R22 received by the receiving antenna 202, the channel matrix H1, and the channel matrix H2. Note that the radio terminal 200 can figure out the components of the channel matrix H1 by causing the SISO-AF relay node 300-1 or the SISO-AF relay node 300-2 to notify the radio terminal 200 of the components of the channel matrix H1 when the SISO-AF relay node 300-1, the SISO-AF relay node 300-2, and the radio terminal 200 synchronize with each other, for example.

As described above, the SISO-AF relay node 300-1 and the SISO-AF relay node 300-2 implement two-input two-output MIMO transmission between the macrocell base station 100 and the SISO-AF relay node 300-1 and SISO-AF relay node 300-2, and implement two-input two-output MIMO transmission between the SISO-AF relay node 300-1 and SISO-AF relay node 300-2 and the radio terminal 200.

(1.2) Configuration of SISO-AF Relay Node

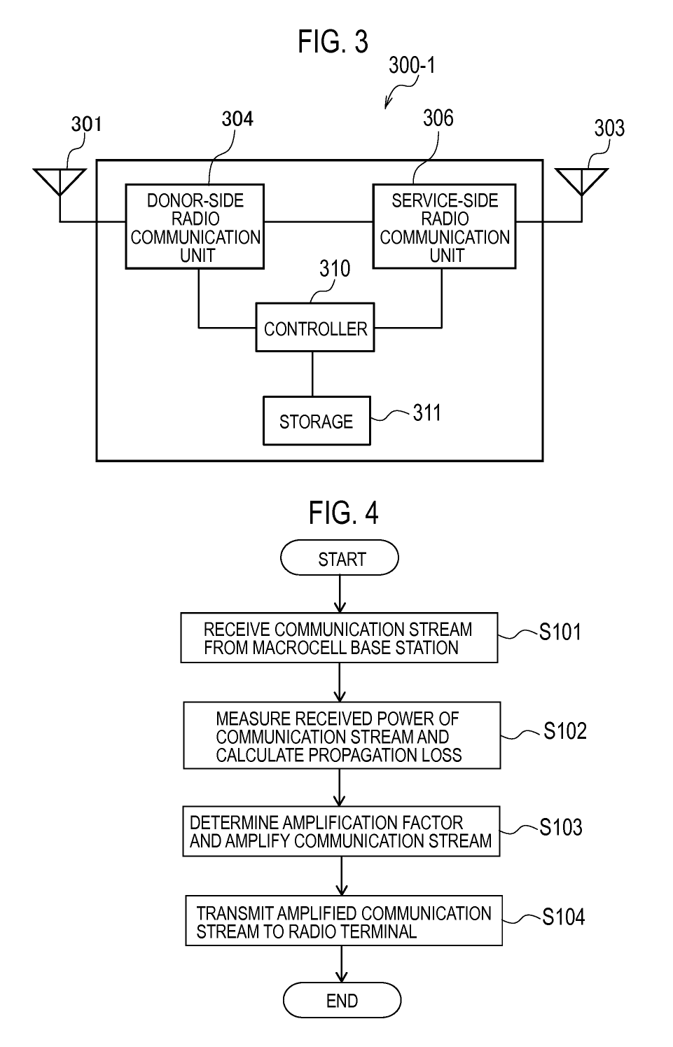

FIG. 3 is a block diagram showing the configuration of the SISO-AF relay node 300-1. Note that the configuration of the SISO-AF relay node 300-2 is similar.

As shown in FIG. 3, the SISO-AF relay node 300-1 includes the receiving antenna 301, the transmitting antenna 302, a donor-side radio communication unit 305, a service-side radio communication unit 306, a controller 310, and a storage 311.

The receiving antenna 301 is configured to receive the signals of the communication stream R11 in which the communication stream transmitted by the transmitting antenna 101 of the macrocell base station 100 and the communication stream transmitted by the transmitting antenna 102 of the macrocell base station 100 are synthesized. As mentioned above, the communication stream R11 is h111·S11+h121·S12 by using the channel matrix H1.

The donor-side radio communication unit 305 is configured to receive the signals of the communication stream R11. The donor-side radio communication unit 305 is configured to output the inputted signals of the communication stream R11 to the service-side radio communication unit 306. Moreover, the donor-side radio communication unit 305 is configured to measure the received power of the signals of the communication stream R11 and output the measured value (received-power measured value) to the controller 310.

The controller 310 is formed by using a CPU (Central Processing Unit) or the like, for example, and is configured to control various functions provided in the SISO-AF relay node 300-1. The storage 311 is formed of a memory, for example, and is configured to store various types of information used for control of the SISO-AF relay node 300-1 and other purposes.

The controller 310 receives the received-power measured value from the donor-side radio communication unit 305. The controller 310 calculates the difference between the received-power measured value and the value of the transmission power of the macrocell base station 100, which is already known. Based on this difference, the controller 310 calculates the path loss between the macrocell base station 100 and the SISO-AF relay node 300-1. Here, the path loss includes a distance attenuation, a shadowing loss, and a building penetration loss. The known value of the transmission power of the macrocell base station 100 is stored in the storage 311, for example.

The controller 310 determines an amplification factor in accordance with the path loss between the macrocell base station 100 and the SISO-AF relay node 300-1. Specifically, the controller 310 determines the amplification factor such that the signals of the communication stream transmitted from the transmitting antenna 303 has a power of a predetermined value. The amplification factor is determined such that the larger the path loss is, the larger the amplification factor is. The controller 310 outputs the determined amplification factor to the service-side radio communication unit 306.

The service-side radio communication unit 306 is configured to receive the signals of the communication stream R11 from the donor-side radio communication unit 305 and also receive the amplification factor from the controller 310.

The service-side radio communication unit 306 incorporates an unillustrated amplifier as an amplifying unit and is configured to amplify the signals of the communication stream R11 with the received amplification factor and output them to the transmitting antenna 303. Here, the amplifying characteristic of the amplifier and the amplifying characteristic of the amplifier in the SISO-AF relay node 300-2 are similar to each other and are within a second predetermined range (e.g., being equal). Moreover, the delay characteristic of the amplifier and the delay characteristic of the amplifier in the SISO-AF relay node 300-2 are similar to each other and are within a third predetermined range (e.g., being equal) . The transmitting antenna 303 is configured to transmit the signals of the communication stream S21 after the amplification to the radio terminal 200 located downstream.

The receiving antenna 201 and the receiving antenna 202 inside the radio terminal 200 are each configured to receive the signals of the communication stream in which the communication stream transmitted by the transmitting antenna 303 and the communication stream transmitted by the transmitting antenna 304 inside the SISO-AF relay node 300-2 are synthesized. As mentioned above, the communication stream R21 received by the receiving antenna 201 is h211·S21+h221·S22 by using the channel matrix H2. Moreover, the communication stream R22 received by the receiving antenna 202 is h212·S21+h222·S22 by using the channel matrix 1-12.

(2) Operations of SISO-AF Relay Node

Next, operations of the SISO-AF relay node 300-1 will be described. FIG. 4 is a flowchart showing the operations of the SISO-AF relay node 300-1 according to the embodiment of the present invention. Note that the operations of SISO-AF relay node 300-2 are similar.

In step S101, the receiving antenna 301 inside the SISO-AF relay node 300-1 receives the signals of the communication stream in which the communication stream from the transmitting antenna 101 inside the macrocell base station 100 and the communication stream from the transmitting antenna 102 inside the macrocell base station 100 are synthesized.

In step S102, the SISO-AF relay node 300-1 measures the received power of the signals of the communication stream. Further, the SISO-AF relay node 300-1 calculates the path loss between the macrocell base station 100 and the SISO-AF relay node 300-1 on the basis of the received-power measured value and the known value of the transmission power of the macrocell base station 100.

In step S103, the SISO-AF relay node 300-1 determines the amplification factor in accordance with the calculated path loss so that the signals of the communication stream transmitted from the transmitting antenna 303 has a power of the predetermined value. Further, the SISO-AF relay node 300-1 amplifies the signals of the communication stream with the determined amplification factor.

In step S104, the transmitting antenna 303 inside the SISO-AF relay node 300-1 transmits the signals of the communication stream after the amplification to the radio terminal 200 located downstream.

(3) Operations and Effects

The SISO-AF relay node 300-1 and the SISO-AF relay node 300-2 in the relay node system 1 according to this embodiment receive the signals of the communication streams from the transmitting antenna 101 and the transmitting antenna 102 inside the macrocell base station 100 located upstream through the receiving antenna 301 and the receiving antenna 302, amplify the signals of the communication streams, and then transmit them to the radio terminal 200 located downstream through the transmitting antenna 303 and the transmitting antenna 304. Thus, MIMO transmission for simultaneously transmitting different communication streams by use of the same frequency is implemented.

Accordingly, the radio communication between the macrocell base station 100 and the radio terminal 200 can be relayed at low cost without using a costly two-input two-output MIMO relay node.

Moreover, since the SISO-AF relay node 300-1 and the SISO-AF relay node 300-2 can be placed away from each other, the inter-antenna distance can be widened and influence on the spatial correlation can therefore be reduced, as compared to a case of using a single MIMO relay node to implement the radio communication between the macrocell base station 100 and the radio terminal 200. Accordingly, the reception performance is improved. Improvements in throughput performance and rank characteristic have been confirmed in the present inventor's simulation.

Moreover, the SISO-AF relay node 300-1 and the SISO-AF relay node 300-2 are installed in the locations where the propagation loss between them and the macrocell base station 100 is within the first predetermined range. Thus, the received powers of the signals of the communication streams received by the receiving antenna 301 inside the SISO-AF relay node 300-1 and by the receiving antenna 302 inside the SISO-AF relay node 300-2 can fall within a predetermined range. Accordingly, the spatial multiplexing effect can be improved as compared to a case where either of the radio paths extending from the transmitting antenna 101 and the transmitting antenna 102 to the receiving antenna 301 and the radio paths extending from the transmitting antenna 101 and the transmitting antenna 102 to the receiving antenna 302 is dominant.

Moreover, the SISO-AF relay node 300-1 and the SISO-AF relay node 300-2 change the amplification factors for the signals of the communication streams in accordance with the path loss between them and the macrocell base station 100. Thus, even under an environment where the path loss varies frequently or in a case where the SISO-AF relay node 300-1 and the SISO-AF relay node 300-2 are not installed in the locations where the propagation loss between them and the macrocell base station 100 is within the first predetermined range, the SISO-AF relay node 300-1 and the SISO-AF relay node 300-2 can absorb an increase and a decrease in received power caused by the difference in path loss. Accordingly, the spatial multiplexing effect can be improved.

Moreover, in each of the SISO-AF relay node 300-1 and the SISO-AF relay node 300-2, the service-side radio communication unit 306 serving as the amplifying unit has its amplifying characteristic within the second predetermined range and its delay characteristic within the third predetermined range. Thus, the amplitude and phase of each of the received powers of the signals of the communication streams received by the receiving antenna 201 and the receiving antenna 202 in the radio terminal 200 can fall within predetermined ranges. Accordingly, the performance of separating the communication streams can be improved.

(4) Other Embodiments

As described above, the present invention has been described according to the embodiments. However, it should not be understood that the descriptions and drawings constituting a part of the present disclosure limit the present invention. Various alternative embodiments, examples, and operational techniques will be apparent for those skilled in the art from this disclosure.

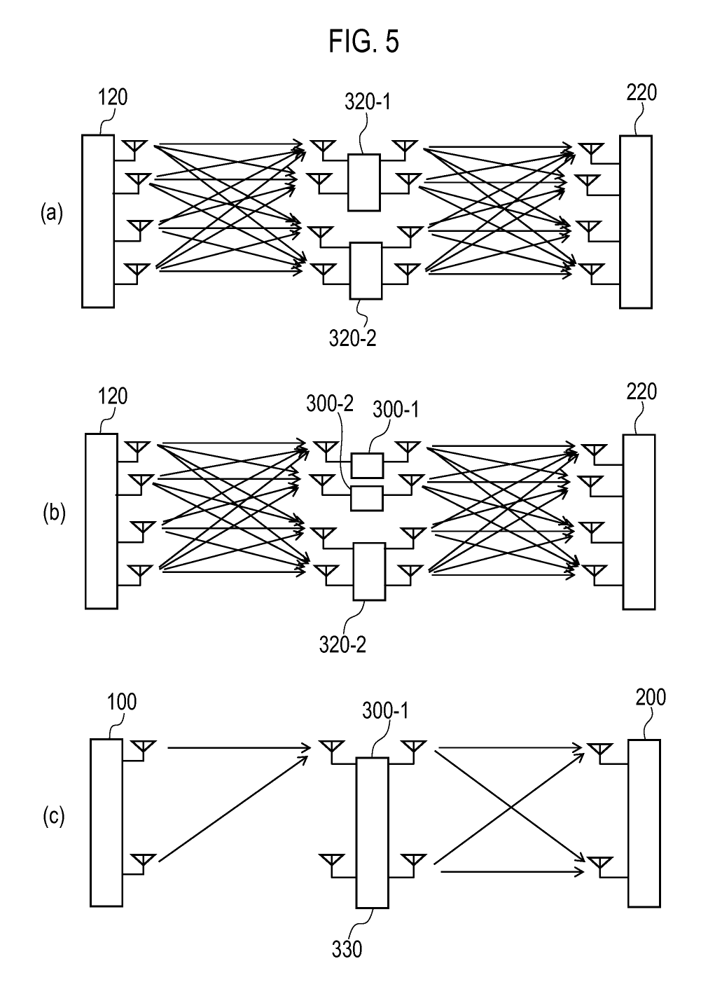

While the relay node system implements two-input two-output MIMO transmission in the foregoing embodiment, the type of MIMO transmission is not limited to the above case. For example, it is possible to implement four-input four-output MIMO transmission as shown in Part (a) and (b) of FIG. 5. In Part (a) of FIG. 5, the relay node system is formed of a two-input two-output MIMO relay node 320-1 and a two-input two-output MIMO relay node 320-2. Moreover, in Part (b) of FIG. 5, the relay node system is formed of the SISO-AF relay node 300-1, the SISO-AF relay node 300-2, and a two-input two-output MIMO relay node 320-2. These cases can achieve a cost reduction as compared to a case where the relay node system is formed of a single four-input four-output MIMO relay node.

Alternatively, as shown in Part (c) of FIG. 5, the relay node system may be formed of a relay node including fewer receiving antennas than the transmitting antennas of the macrocell base station 100 located upstream.

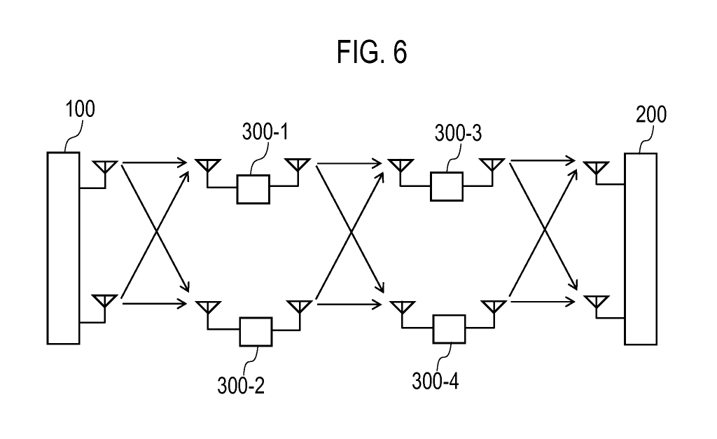

Alternatively, as shown in FIG. 6, multiple relay node systems may be formed in radio paths extending from the transmitting antennas of the macrocell base station 100 to the receiving antennas of the radio terminal 200. In FIG. 6, the SISO-AF relay node 300-1 and the SISO-AF relay node 300-2 inside the upstream relay node system form the same relay stage, while an SISO-AF relay node 300-3 and an SISO-AF relay node 300-4 inside the downstream relay node system form the same relay stage.

In the foregoing embodiment, the radio communication system performs downlink radio communication directed from the macrocell base station 100 through the SISO-AF relay node 300-1 and the SISO-AF relay node 300-2 to the radio terminal 200. However, the present invention can be applied similarly to uplink radio communication directed from the radio terminal 200 through the SISO-AF relay node 300-1 and the SISO-AF relay node 300-2 to the macrocell base station 100.

In the foregoing embodiment, the SISO-AF relay node 300-1 and the SISO-AF relay node 300-2 independently relay the signals for the MIMO transmission performed between the macrocell base station 100 and the radio terminal 200. However, the transmissions from the SISO-AF relay node 300-1 and the SISO-AF relay node 300-2 may be synchronized. In this case, each relay node includes a controller for controlling the transmission timing and a wired or wireless interface for exchanging signals for the synchronization control between the controllers provided to the relay nodes. A given synchronization process is executed with a trigger being the timing at which one of the relay nodes first receives a signal from the macrocell base station 100. Note that this synchronization process may be executed periodically.

Moreover, while the radio communication system has a configuration based on LTE-Advanced in the foregoing embodiment, the configuration may be based on a different communication standard such as 3GPP-Release 9.

It should be understood that the present invention includes various embodiments which are not described herein. Accordingly, the present invention is only limited by the scope of the claims and matters specifying the invention, which are appropriate from this disclosure.

Note that the entire content of Japanese Patent Application No. 2010-095545 (filed on Apr. 16, 2010) is incorporated in the present specification by reference.

### INDUSTRIAL APPLICABILITY

The communication system, the communication relay device and the communication control method of the present invention are applicable to a communication system, a communication relay device and a communication control method, by which it is possible to achieve both a low cost and an improved reception performance.

1. A communication system comprising a plurality of communication relay devices configured to relay radio communication between a first communication device and a second communication device, wherein
each of the plurality of communication relay devices comprises:
a receiving antenna being not greater in number than one or more transmitting antennas in the first communication device or other communication relay devices, and configured to receive signals of communication data series from the transmitting antennas in the first communication device or other communication relay devices;
an amplifying unit configured to amplify the signals of the communication data series received by the receiving antenna; and
a transmitting antenna configured to transmit the signals of the communication data series amplified by the amplifying unit to the second communication device or other communication relay devices, wherein
MIMO (Multi Input Multi Output) transmission is performed between the first communication device and the second communication device through the plurality of communication relay devices, the MIMO transmission being designed to transmit signals of different communication data series by using the same frequency.

2. The communication system according to claim 1, wherein the plurality of communication relay devices are each installed in a location where a propagation loss between the communication relay device and the first communication device is within a first predetermined range.

3. The communication system according to claim 1, wherein the amplifying unit changes an amplification factor in accordance with a path loss between the communication relay device and the first communication device.

4. The communication system according to claim 1, wherein at least one of the plurality of communication relay devices performs SISO (Single Input Single Output) transmission.

5. The communication system according to claim 1, wherein the amplifying unit in each of the plurality of communication relay devices has an amplifying characteristic within a second predetermined range and a delay characteristic within a third predetermined range.

6. A communication relay device configured to relay radio communication between a first communication device and a second communication device in cooperation with other communication relay devices, the communication relay device comprising:
a receiving antenna being not greater in number than one or more transmitting antennas in the first communication device or other communication relay devices, and configured to receive signals of communication data series from the transmitting antennas in the first communication device or other communication relay devices;
an amplifying unit configured to amplify the signals of the communication data series received by the receiving antenna; and
a transmitting antenna configured to transmit the signals of the communication data series amplified by the amplifying unit to the second communication device or other communication relay devices, wherein
the communication relay device performs MIMO (Multi Input Multi Output) transmission between the first communication device and the second communication device in cooperation with the other communication relay devices, the MIMO transmission being designed to transmit signals of different communication data series by using the same frequency.

7. A communication control method for a communication system comprising a plurality of communication relay devices configured to relay radio communication between a first communication device and a second communication device, the communication control method comprising the steps of:
causing a receiving antenna in each of the plurality of communication relay devices, which is not greater in number than one or more transmitting antennas in the first communication device or other communication relay devices, to receive signals of communication data series from the transmitting antennas in the first communication device or other communication relay devices;
causing each of the plurality of communication relay devices to amplify the received signals of the communication data series; and
causing the one or more transmitting antennas in each of the plurality of communication relay devices to transmit the amplified signals of the communication data series to the second communication device or other communication relay devices, wherein
MIMO (Multi Input Multi Output) transmission is performed between the first communication device and the second communication device through the plurality of communication relay devices, the MIMO transmission being designed to transmit signals of different communication data series by using the same frequency.
